(19) United States
(12) Patent Application Publication
(10) Pub. No.: US 2009/0073564 A1
(43) Pub. Date: Mar. 19, 2009

(54) Optical film having light-scattering substrate and the process thereof

(76) Inventor: Ching-Bin Lin, Taipei (TW)

Correspondence Address: Ching-Bin Lin, P. O. Box 55-846, Taipei, 104, TW

(21) Appl. No.: 11/900,832

(22) Filed: Sep. 14, 2007

(51) Int. Cl. G02B 5/02

(52) U.S. Cl. 359/599; 359/831

(57) ABSTRACT

An optical film comprises a light-scattering substrate capable for diffusing light incoming through the substrate, and a prismatic layer having an array of a plurality of prisms and formed on the substrate for concentrating light when outgoing from the prisms, thereby obtaining an optical film for enhancing its brightness and light uniformity simultaneously.

### BACKGROUND OF THE INVENTION

U.S. Pat. No. 6,280,063 disclosed a brightness enhancement article including a transparent substrate, a prism-array upper layer formed on the upper portion of the substrate, and a lower layer characterized by a plurality of light scattering protrusions formed on the bottom portion of the substrate.

However, such a prior art has the following drawbacks:
1. The lower layer is formed by dispersing particles including silica, alumina, calcium carbonate, and glass beads in a polymeric resin formed on the bottom surface of the substrate to allow the light scattering protrusions to protrude downwardly from the substrate bottom, lacking of any crosslinking mechanism at the interface between the light scattering protrusions and the substrate bottom and easily causing delamination between the layers of the optical film thus formed.
2. Three layers, namely the upper prism layer, the middle substrate layer and the lower layer of light scattering protrusions, for forming the optical film may increase the production complexity and cost thereof.
3. The optical film, as composed of three layers, may not be so slim or thin, which may limit its commercial or industrial application in commercial or industrial application in modern sophisticated information, communication or electronic technologies.

The present inventor has found the drawbacks of the prior art and invented the present novel optical film as formed by only two layers.

### SUMMARY OF THE INVENTION

The object of the present invention is to provide an optical film comprising a light-scattering substrate capable for diffusing light incoming through the substrate, and a prismatic layer having an array of a plurality of prisms and formed on the substrate for concentrating light when outgoing from the prisms, thereby obtaining an optical film for enhancing its brightness and light uniformity simultaneously.

### BRIEF DESCRIPTION OF THE DRAWINGS

FIG. 1 is a sectional drawing of the present invention.

FIG. 2 is a sectional drawing of a second preferred embodiment of the present invention.

FIG. 3 is a sectional drawing of a third preferred embodiment of the present invention.

### DETAILED DESCRIPTION

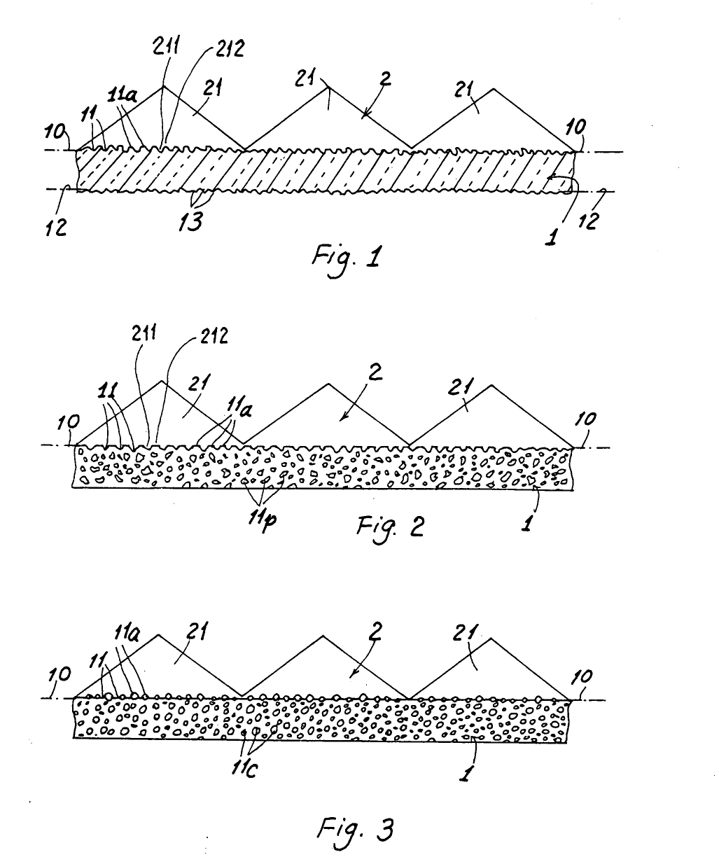

As shown in FIG. 1, the optical film of the present invention comprises: a light-scattering substrate 1, and a prismatic layer 2 having an array of prisms 21 or having a plurality of prisms 21 formed on the substrate 1.

The light-scattering substrate 1 includes an upper concave and convex portion 11, 11a formed on an upper portion of the substrate 1 and interposed between the substrate 1 and the prismatic layer 2, including a plurality of concave portions 11 and a plurality of convex portions 11a continuously formed on the upper portion of the substrate and contiguous to a lower portion of the prismatic layer 2 to form a light scattering portion (or light diffusing portion) for the light-scattering substrate 1; and also to form an interlocking mechanism or structure between the prismatic layer 2 and the substrate 1 since the concave portion 11 of the substrate 1 will be engaged with a corresponding protrusion 211 protruding downwardly from each prism 21 of the prismatic layer 2, and the convex portion 11a of the substrate 1 will be engaged with a corresponding recess 212 as recessed upwardly from the bottom of each prism 21 of the prismatic layer 2, thereby firmly interlocking the prismatic layer 2 with the substrate 1.

The prisms 21 of the prismatic layer 2 play the role of light concentrating when projecting light outwardly or upwardly from the prisms 21; while the concave and convex portion 11, 11a of the substrate 1 plays the role of light scattering or light diffusing, thereby forming an optical film capable for light concentrating for increasing the brightness thereof and also capable of light scattering for increasing the light uniformity, merely by a two-layer optical film, i.e., the upper prismatic layer 2 and the lower substrate layer 1, for decreasing the production cost thereof and for thinning the optical film just composed of two layers, rather than three layers or multiple layers of conventional films.

As shown in FIG. 1, the bottom 12 of the substrate 1 may also be formed with a lower concave and convex portion 13 to form a light scattering or light diffusing portion on the bottom of the substrate 1.

However, the bottom 12 of the substrate 1 may also be made as a planar bottom surface, forming another modification of the present invention.

As shown in FIG. 2, the light-scattering substrate 1 may be formed with porosity therein, namely having a plurality of light-scattering pores 11p formed in the substrate 1 for rendering the light diffusing property for the substrate 1 and the optical film of the present invention.

The pores 11p each formed on the upper surface portion of the substrate 1 (FIG. 2) will be equivalent to a concave portion 11 as aforementioned and illustrated in FIG. 1, while the interface 10 between prismatic layer 2 and the substrate 1 will be a planar surface, which will be formed as a “convex portion 11a” with respect to the concave portion 11 as formed by the pore 11p in the substrate 1 as shown in FIG. 2.

The concave portion 11 and convex portion 11a formed on the upper surface of the substrate 1 will be correspondingly, respectively engaged with the protrusion 211 and the recess 212 formed on the lower portion of the prismatic layer 2, thereby also forming an interlocking mechanism for firmly “fastening” the prismatic layer 2 on the substrate 1.

The pores 11p in the substrate 1 will provide a light diffusing property for the substrate and the optical film thus formed; and the pores on the upper surface of the substrate 1 will be “interlocked” with the prismatic layer 2, thereby firmly combining the prismatic layer 2 with the substrate 1 for simultaneously enhancing the mechanical property and the optical property.

The light diffusing property as effected by the substrate 1 will enhance the light uniformity of the optical film and optical device thus formed; while the prisms 21 of the prismatic layer 2 will enhance the light concentrating property and accordingly increase the brightness of the optical film and optical device thus formed.

As shown in FIG. 3, the substrate 1 is formed with a plurality of light-scattering crystal phases (or crystals) 11c therein for forming a light scattering substrate as effected by the crystals formed in the substrate 1.

The crystals or crystal phases 11c each formed on the upper surface of the substrate 1 will be a convex portion 11a above the interface 10 between the prismatic layer 2 and the substrate 1, while the planar surface of the interface 10 will be a “concave portion 11” with respect to the convex portion 11a as formed by the crystal 11c protruding upwardly from the planar surface of the interface 10, thereby forming an interlocking structure between the prismatic layer 2 and the substrate 1 for firmly combining the prismatic layer 2 with the substrate 1.

The crystals 11c in the substrate 1 will render the light scattering property of the substrate 1, thereby providing an optical film having light scattering as effected by the substrate 1 and the light concentrating as effected by the prisms 21 of the prismatic layer 2.

The crystals 11c may be formed in-situ in the substrate 1 by crystallization process; or the crystals may be added into the substrate 1 to render the light scattering property for the substrate. The crystals as provided or formed in the substrate may be organic or inorganic crystals, not limited in the present invention.

The substrate 1 may be added with light-scattering fillers or particles therein for forming an amorphous light-scattering substrate.

The particles as used in the present invention include: silica, alumina, calcium carbonate, glass beads and organic particles.

The substrate 1, besides its light-scattering property, should have the following properties: good transparency, proper structural strength, optical strength, optical temperature, anti-aging, anti-scratching properties, adapted for making optical articles or products.

The substrate may be made of thermoplastic resin, including: polyethylene terephthalate (PET), polycarbonate (PC), polystyrene, polymethyl methacrylate, etc.

The prismatic layer 2 may be made of photocurable resin (including UV resin) or heat curable resin, which may be cured or hardened when subjected to light or UV radiation, electric heating or other heating.

However, the materials for making the present invention are not limited, and may be properly chosen in accordance with the practical requirements of the present invention.

The concave or convex portion 11, 11a of the substrate of the present invention may be selected from the shapes including: arcuate shape, saw-toothed shape, triangular shape, prismatic shape, regular or irregular shapes, not limited in this invention.

The present invention may be modified without departing from the spirit and scope of the present invention.

The concave and convex portion 11, 11a of the substrate 1 may also be eliminated when the interlocking mechanism between the prismatic layer 2 and the substrate 1 is not required in some commercial applications. By the way, the prismatic layer 2 may be directly formed on the substrate 1 without consideration of the interlocking mechanism as aforementioned.

The pores, crystals, or particles may be fully distributed in the substrate; or may be partially formed in a portion or a layer in the substrate 1.

1. An optical film comprising:
a light-scattering substrate operatively diffusing light as incoming through the substrate; and
a prismatic layer having a plurality of prisms and formed on said substrate, and operatively concentrating light when output from said prisms of said prismatic layer;
said substrate including a concave and convex portion formed on an upper portion of said substrate along an interface between said substrate and said prismatic layer, said concave and convex portion of said substrate operatively scattering or diffusing light when incoming through said substrate; and
the improvement which comprises:
said concave and convex portion of said substrate including at least a concave portion recessed downwardly from an upper portion of said substrate, and engaged with a protrusion protruding downwardly from a lower portion of said prismatic layer; and at least a convex portion protruding upwardly from the upper portion of said substrate, and engaged with a recess recessed upwardly from the lower portion of said prismatic layer, thereby forming an interlocking mechanism in situ between said prismatic layer and said substrate.

2-7. (canceled)
